(19) United States
(12) Patent Application Publication
(10) Pub. No.: US 2002/0093244 A1
(43) Pub. Date: Jul. 18, 2002

(54) Electrical feedback fashion brake protector device

(76) Inventors: Hsien-Chiarn Lee, Taipei (TW); Chih-Tung Chen, Taoyuan Hsien (TW); Fu-Chang Hsu, Taoyuan (TW)

Correspondence Address: J. C. PATENTS INC., 4 VENTURE, SUITE 250, IRVINE, CA, 92618, US

(21) Appl. No.: 09/749,049

(22) Filed: Dec. 27, 2000

(51) Int. Cl. B60T 13/68; F16D 65/36; B60T 15/14

(52) U.S. Cl. 303/20; 188/157

(57) ABSTRACT

An electrical feedback fashion brake arrester is provided with a motor movement automatic detecting and differentiating device that is mounted in the control loop of the electrical feedback fashion brake arrester. The motor movement automatic detecting and differentiating device receives the existing stroke position feedback signal, determines whether the brake members are in locking configuration, and determines whether the duty cycle and the current of the driving motor should be limited. Hence, the current that is output when the motor is at rest does not exceed that of the maximum sustainable torque force so that the electrical arrester is prevented from being damaged.

### BACKGROUND OF THE INVENTION

1. Field of the Invention

The invention relates to a protector device for electrical brakes. More particularly, the invention relates to an electrical feedback fashion protector device for brake devices.

2. Description of the Related Art

Emphasis is placed on making brake devices where the mechanical structure is simple, to facilitate maintenance and adjustment, so that the cost can be reduced while the lifetime is extended. For the foregoing reasons, electrical control brake devices are gradually being used in modern brake products.

Conventionally, brake devices are usually divided into two categories: “Continuous fashion brake devices” and “Two stroke fashion brake devices”. The mechanism of a Continuous fashion brake device consists of passing from a state of complete release to a state of continuous braking. In turn, a Two stroke fashion brake device, well known as the ABS system, consists of a sequence of a time of braking and a time of releasing.

The purpose of an electrical control brake device is to use an electrical command to control the stroke and the force of the brakes. Conventionally, the electrical control brake device is comprised of an electrical arrester that is connected to a transmission bar, whether directly or through the intermediary of springs or pneumatics. The transmission bar is in turn coupled to the brake members. The electrical arrester, that comprises a motor, receives a command stroke position that is transmitted, via the motor, to assign the stroke position of the the transmission bar, that in turn guides the brake members stroke. Inasmuch as the brake members stroke is limited, when this limit is attained, even if the output of the arrester increases, the brake members stroke cannot increase further. Conventionally, the stroke position of the transmission bar feedback signal is compared to the command stroke position received by the electrical arrester. If there is an error between the command stroke position and the stroke position of the transmission bar, a current is generated to drive the motor so that it rotates in a direction such that the error should be reduced. The intensity of the driving current is dependent on the stroke position error and also on the torque force that is output by the motor. Specifically, when the motor is at rest while the current is maximal, the configuration thus attained is that of “the maximum static torque force”. Usually, the maximum static torque force cannot be sustained without inducing damage. Thus, the conventional arrester is designed in such a manner that it can sustain “a maximum sustainable static torque force” that is smaller than the “maximum static torque force”. The following equations are introduced to describe in further detail the arrester motor operation.

E=Rₐ·Iₐ+E_{b} (2-1)

E_{b}=K_{b}·ω (2-2)

T=Kₜ·Iₐ (2-3)

W=Iₐ²·Rₐ (2-4)

wherein,

E is the power voltage,

Rₐ is the armature resistance,

Iₐ is the armature current,

E_{b} is the anti-electromotive voltage,

K_{b} is the anti-electromotive constant,

ω is the motor rotation velocity,

T is the torque force,

Kₜ is the torque force constant, and

W is the heat dissipation puissance.

According to the equations (2-1) and (2-2), when the motor starts rotating or when it is prevented from rotating, the rotation velocity ω=0, and the anti-electromotive voltage E_{b}=K_{b·ω=0}, while the armature current Iₐ is maximum. According to equation (2-3), the torque force of the motor is consequently maximal. Equation (2-4) shows that the heat that is dissipated by the motor circuit is increased as the armature current Iₐ increases. If the configuration in which the current Iₐ is set to the maximum is maintained while the heat dissipation of the motor is not effective, it can result in a burning down of the motor circuit. Consequently, sustaining maximum armature current, which is the case when the maximum sustainable static torque force is attained, is the primary cause of motor damage. This critical issue is all the more frequently met when the stroke of the conventional transmission bar is small and, as a result, the command stroke is rapidly attained and may be unawares sustained.

Typically, an excessive command stroke of brake locking leads to the configuration of the maximum sustainable static torque force described above, which can cause damage to the brake members or damage to the arrester. A conventional solution is the mounting of a series of connection springs, a hydraulic or pneumatic device, or other buffer devices, to the transmission bar between the arrester and the brake members, in order to extend the stroke of the transmission bar and absorb the stroke error. However, this solution makes the structure of the general brake device more complicated. Moreover, the stroke extension should not be excessive, which would negatively influence the reaction time of the brake device.

Reference will now be made in detail to the operating of the conventional electrical arrester of a brake device, with the help of FIG. 1 and FIG. 2. FIG. 1 shows a portion of the brake device while FIG. 2 shows a block diagram of the conventional electrical arrester. A conventional brake device comprises brake members (12, 22) that press rotating elements (10, 20). Through the friction forces that are thereby generated, the rotating elements (10, 20) are slowed down or stopped. However, once the brake members (12, 22) tightly press the rotating elements 10 and 20, the stroke 35 cannot increase further, which defines the limit of the stroke 35. Thus, if the electrical arrester 100 receives a command stroke that is greater than the limit of the stroke 35 of the brake members (12, 22), the stroke 35 cannot increase. Conventionally, the electrical arrester 100 comprises a driving gate duty cycle generator 102 in the control loop and, mounted thereafter, a motor 106. The motor 106 is connected to brake members 122 through a transmission bar 120. The driving gate duty cycle generator 102, according to the error between the command stroke that is received and the stroke that the transmission bar 120 outputs, delivers a gate opening duty cycle to the motor driving circuit 104 to drive the motor 106 and thus the stroke of the transmission bar 120. Theoretically, the conventional electrical arrester 100, according to the design of its structure and its circuitry, and the motor 208 capacitance, has a maximum sustainable static torque force threshold. However, the command stroke of brake locking usually exceeds the actual locking stroke. As a result, the arrester 100 or the motor 106 can be in the configuration wherein the maximal sustainable static torque force is attained for a period of time that can be substantially long. The armature current is consequently maximal and thus can induce damage to the arrester 100 and the motor 106. Therefore, it is necessary to frequently perform an accurate adjustment of the brake members 122 locking stroke. To attenuate this inconvenience, the conventional method, referred to above, mounts buffer devices on the transmission bar to absorb a part of the stroke error. However, this solution makes the structure more complex and is still limited.

### SUMMARY OF THE INVENTION

The invention relates to an electrical feedback protector device for brake devices. More particularly, the invention relates to the use of a motor movement automatic detecting and differentiating device that is mounted in the control loop of the electrical brake arrester. The motor movement automatic detecting and differentiating device is mounted in such a manner that it receives a feedback signal from the transmission bar stroke, evaluates whether the brake members are in a locking configuration, and consequently decides whether the duty cycle of the driving motor should be limited such that when the motor is at rest, the current that is output does not exceed that of the maximum sustainable static torque force.

Therefore, according to an advantage of the invention, the electrical arrester is protected from the output of an excessive current.

According to another advantage of the invention, although the command stroke of the brake locking may exceed the actual locking stroke, the electrical arrester is still protected and prevented from attaining the maximal current of the maximum sustainable torque force.

According to another advantage of the invention, the use of buffer devices is no longer necessary and the adjustment and maintenance of the entire brake device are thus simplified.

It is to be understood that both the foregoing general description and the following detailed description are exemplary, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention. In the drawings,

FIG. 1 shows a schematical view of the brake members;

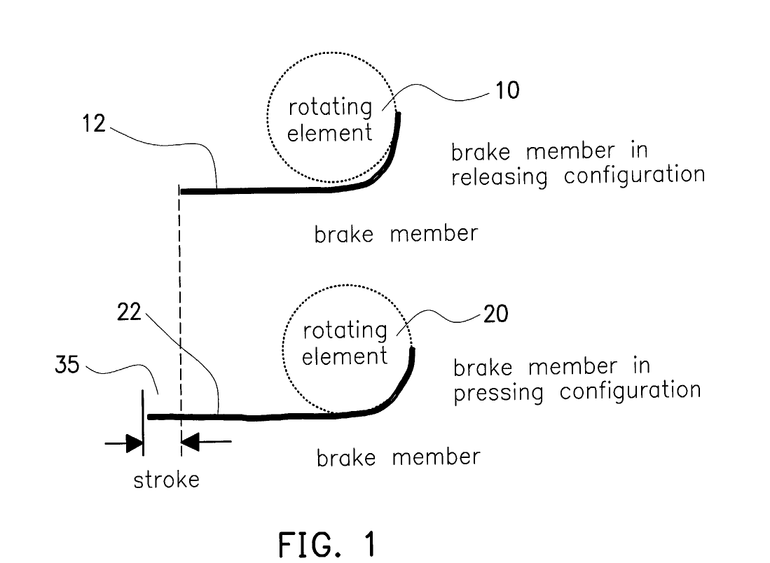

FIG. 2 shows a block diagram of a conventional electrical brake arrester;

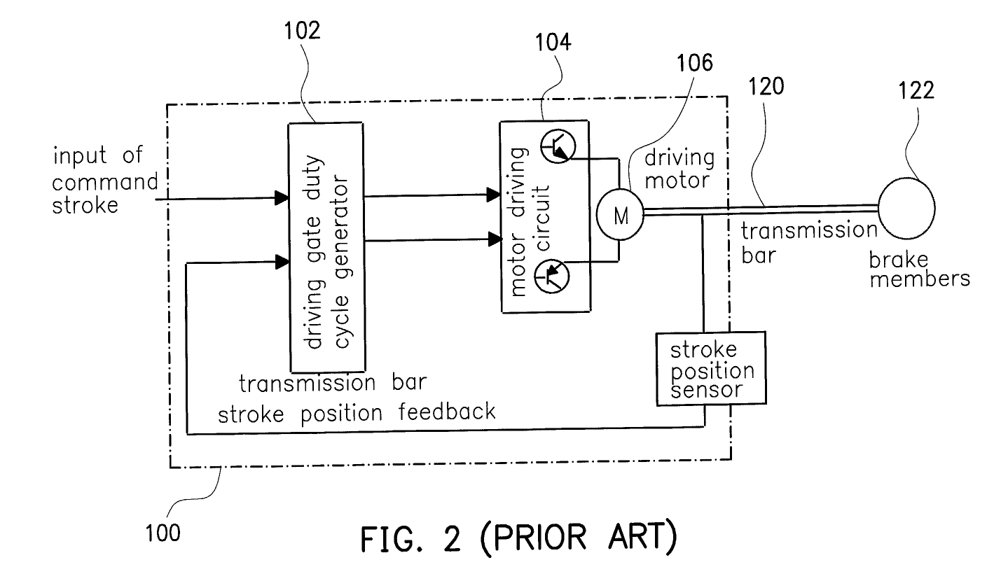

FIG. 3 shows a block diagram of the electrical feedback fashion arrester, according to an embodiment of the invention;

FIG. 4 shows a graph depicting the relationship between the stroke error and the output of the driving gate duty cycle generator, according to an embodiment of the invention;

FIG. 5 shows a graph depicting the relationship between the stroke error and the output of the motor movement automatic detecting and differentiating device, according to an embodiment of the invention; and

FIG. 6 shows an example of the output/time diagrams of the motor movement automatic detecting and differentiating device, according to an embodiment of the invention.

### DESCRIPTION OF THE PREFERRED EMBODIMENTS

Hereinafter embodiments of the present invention will be explained concretely with reference to the accompanied drawings.

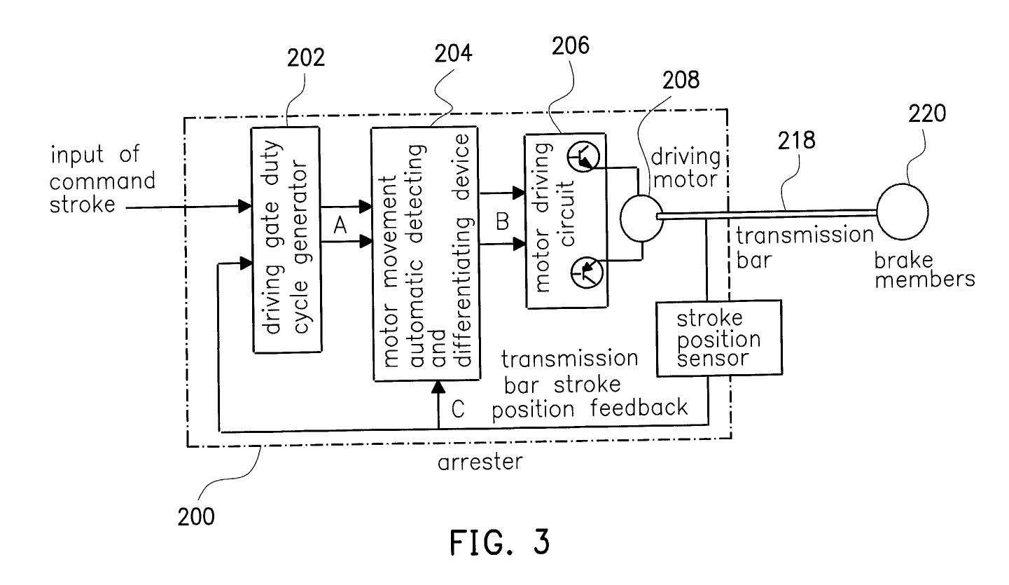

FIG. 3 shows a block diagram of an electrical feedback fashion arrester 200 according to a first embodiment of the invention. A motor movement automatic detecting and differentiating device 204 is mounted in the control loop of the electrical feedback fashion arrester 200, between a driving gate duty cycle generator 202 and a motor driving circuit 206. According to the error between the command stroke that is received and the feedback signal of the stroke that is output by the transmission bar 218 of the arrester, the driving gate duty cycle generator 202 commands both the direction of the motor 208 driving current and the duty cycle of the driving gate opening.

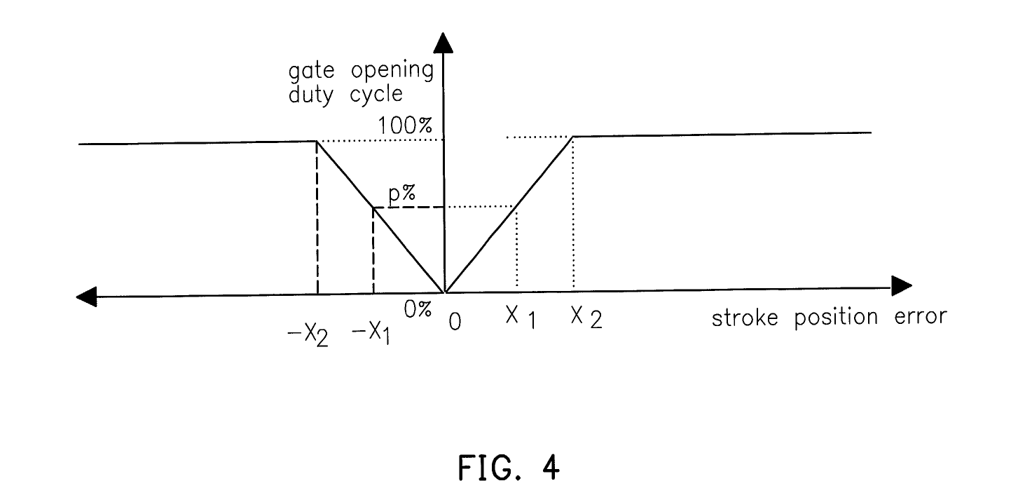

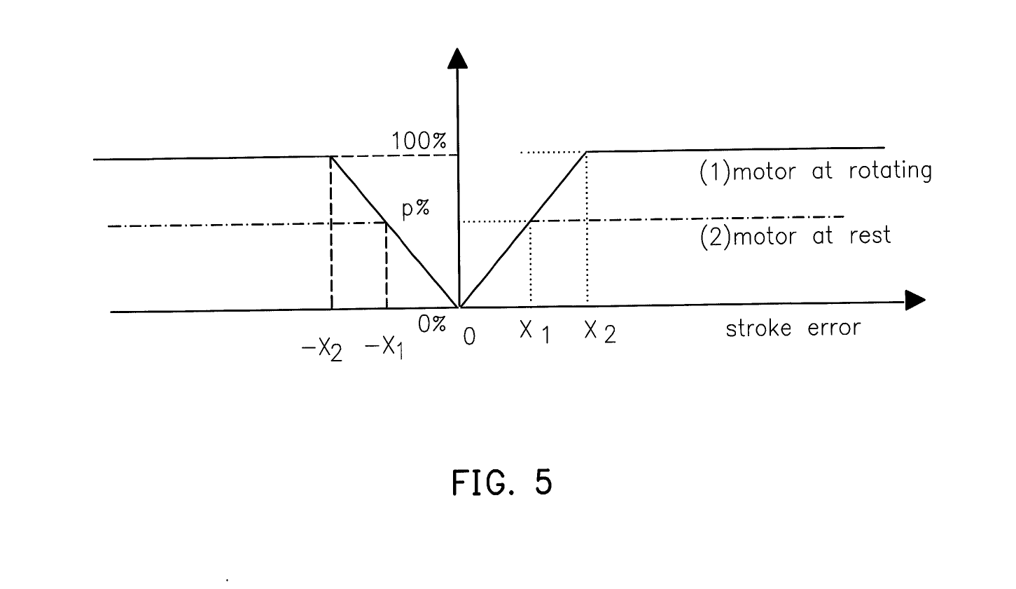

FIG. 4 is a graph showing the relationship between the output of the driving gate duty cycle generator 202, which varies from 0% to 100%, and the stroke position error. FIG. 5 is a graph showing the relationship between the output of the motor movement automatic detecting and differentiating device 204 and the stroke position error. In both graphs FIG. 4 and FIG. 5, the abscissa axis represents the stroke position error while the ordinate axis represents the driving gate opening duty cycle. The driving gate opening duty cycle is shown as being proportional to the stroke position error. When the value of the stroke position error is zero, the value of the duty cycle that is output is zero. When the absolute value of the stroke position error is higher than a value X₂, the value of the duty cycle that is output is 100%. If the error is negative, that means the direction of the motor 208 current has changed. If the motor 208 is at rest and the absolute value of the stroke position error is value X₁, the electric arrester 200 outputs a maximum sustainable static torque force at that moment while the duty cycle is set to a value p %. For a same duty cycle, when the motor 208 is at rest, the average of the current that passes through the motor 208 is greater than the current that passes through the motor 208 when it is rotating. Thus, when the motor 208 is at rest, if the error value is greater than the value X₂, the average current that passes through the motor 208 is maximum. At that moment, the electrical arrester 200 is in a configuration wherein the maximum static torque force is output. If the motor 208 is at rest and the duty cycle is value p %, the arrester 200 is in a configuration wherein a maximum sustainable static torque force is output. Thus, if the motor movement automatic detecting and differentiating device 204 of the invention is mounted to fetch the feedback signal of the stroke position, the duty cycle of the driving gate opening, that is output by the driving gate duty cycle generator 202, can be controlled. Depending on whether the variation rate of the feedback stroke position of the transmission bar 218 is within a given numerical range, the motor movement automatic detecting and differentiating device 204 evaluates whether the motor 208 is in a rest configuration or rotates a given angle. If the motor 208 is at rest and the absolute value of the stroke position error is greater than the value X₁, the duty cycle value that is output can be limited to the value p %, as is shown by the dash dot line (2) in FIG. 5. If the motor 208 is in a rotating configuration or rotates an angle that is greater than a given value, that means the motor 208 outputs a current that is smaller or equal to the average current. Thus, the motor movement automatic detecting and differentiating device 204 outputs the current that was delivered from the driving gate duty cycle generator 202 without any limitation action, as it is shown by the full line (1) in FIG. 5.

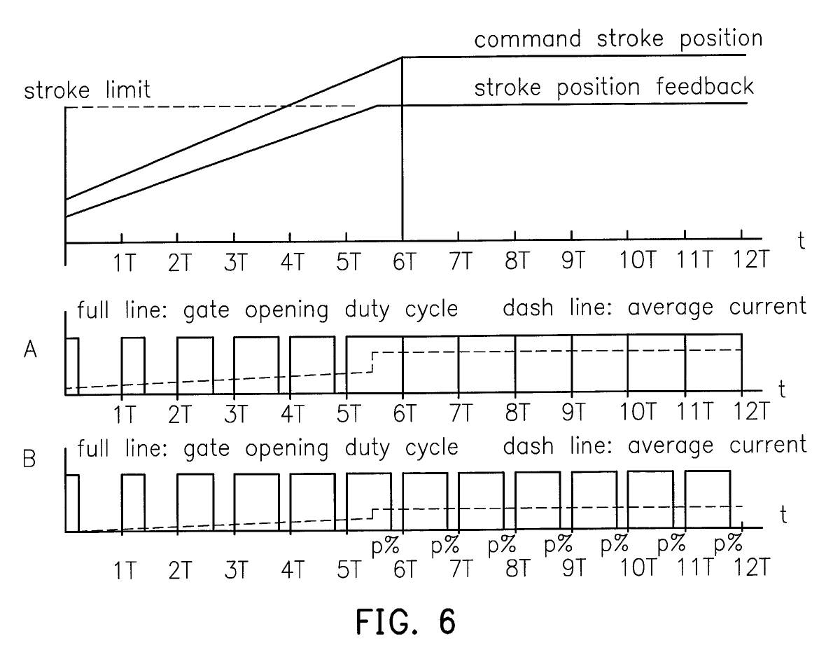

FIG. 6 shows an example of the output/time diagram when the motor movement automatic detecting and differentiating device 204 is added, according to an embodiment of the invention. In the output/time diagram A of the conventional electrical arrester, the full line shows the duty cycle that is output by the driving gate duty cycle generator 202 while the dash line shows the average current that is output by the driving gate duty cycle generator 202, t is the symbol for the time and T is one full duty cycle. In the output/time diagram B wherein the motor movement automatic detecting and differentiating device 204 is added, the full line shows the duty cycle of the current gate opening that is output while the dash line shows the average current that is output.

In each diagram, when t is within the time interval [0, 5T], the motor 208 is in a rotating configuration. Thus, from the equations of the motor 208 shown above, the anti-electromotive potential E_{b} is not zero while the average current Iₐ is not high. When the time t>5T, the motor 208 is in a rest configuration, thus the anti-electromotive potential is E_{b}=0. If the protector circuit of the invention was not mounted, the value of the average current would have been Iₐ=E/Rₐ and consequently very high. However, when it is added, the motor movement automatic detecting and differentiating device 204 can limit the gate opening duty cycle to the percentage p % while the average current la is also limited to the value of (E/Rₐ)*p %. As a result, the armature coil or the control line (not shown) can be prevented from overheating. Hence, even though the command stroke of the brake locking substantially exceeds the actual locking stroke, the command stroke of the brake locking still cannot damage the arrester 200. Hence, when the settings of the command stroke of the brake locking are carried out, the command stroke can be set such that it exceeds the actual locking stroke position. Thus, the conventional and complicated use of a series of connection springs, hydraulic, pneumatic or other flexible buffer devices mounted on the transmission bar 218 can be avoided. As a result, since the entire brake device is rendered simpler, there is no further need of accurate correction and the adjustment and maintenance operations are substantially simplified.

The present invention has already been tested in the brake system of an aircraft model and can also be applied to the seizing action mechanism of a mechanical arm.

In conclusion, in accordance with the embodiment described above, the invention has the following advantages. According to the first advantage of the invention, the motor movement automatic detecting and differentiating device can limit the average current and the level of the duty cycle under the configuration of maximum sustained static torque force. Thereby, the duty cycle of the current gate opening is prevented from being set to a level that would exceed the level required for the configuration of maximum sustained torque force, which can protect the arrester from damage.

According to another advantage of the invention, the motor movement automatic detecting and differentiating device can permit the command stroke position of the brake locking to substantially exceed the actual locking stroke without damaging the arrester. Thus, there is no need for any buffer devices mounted on the transmission bar. In operating conditions, the adjustment of the command stroke position such that it exceeds the actual stroke position is sufficient. Thus, the need for frequent, accurate corrections of the stroke is prevented, which makes the adjustment and maintenance operation easier.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. An electrical feedback fashion brake arrester that receives a command stroke signal and is coupled to brake members, suitable for a two-stroke fashion electrical brake device, the electrical feedback fashion brake arrester comprising:
a transmission bar, which is coupled to the brake members, wherein the transmission bar outputs a transmission bar stroke feedback signal;
a driving gate duty cycle generator, which receives the command stroke signal and the transmission bar stroke feedback signal and delivers a first duty cycle signal and a first driving current level signal according to the error between the command stroke signal and the transmission bar stroke feedback signal, wherein the duty cycle signal and the current level signal define respectively a duty cycle of a driving gate opening and a current level;
a motor movement automatic detecting and differentiating device, which receives respectively the first duty cycle signal, the first driving current level signal and the transmission bar stroke feedback signal, and outputs a second duty cycle signal and a second driving current level signal, wherein the second duty cycle signal and the second driving current level signal, which are limitation signals of respectively the first duty cycle signal and the first driving current level signal, are determined through the evaluation of the transmission bar stroke feedback signal;
a driving motor, which is connected to the transmission bar and drives the transmission bar stroke; and
a motor driving circuit, which is connected to the driving motor and the motor movement automatic detecting and differentiating device, wherein the motor driving circuit receives the second duty cycle signal and the second driving current level signal to control the duty cycle of the driving gate opening and the current level that supplies the driving motor.

2. The electrical feedback fashion brake arrester of claim 1, wherein the duty cycle corresponding to the second duty cycle signal and the current level corresponding to the second current level signal are respectively inferior or equal to the duty cycle corresponding to the first duty cycle signal and the current level corresponding to the first current level signal.

3. An electrical feedback fashion brake arrester that receives a command stroke signal and is coupled to brake members, suitable for a continuous fashion electrical brake device, the electrical feedback fashion brake arrester comprising:
a transmission bar, which is coupled to the brake members, wherein the transmission bar outputs a transmission bar stroke feedback signal;
a driving gate duty cycle generator, which receives the command stroke signal and the transmission bar stroke feedback signal and delivers a first duty cycle signal and a first driving current level signal according to the error between the command stroke signal and the transmission bar stroke feedback signal, wherein the duty cycle signal and the current level signal define respectively a duty cycle of a driving gate opening and a current level;
a motor movement automatic detecting and differentiating device, which receives respectively the first duty cycle signal, the first driving current level signal and the transmission bar stroke feedback signal, and outputs a second duty cycle signal and a second driving current level signal, wherein the second duty cycle signal and the second driving current level signal, which are limitation signals of respectively the first duty cycle signal and the first driving current level signal, are determined through the evaluation of the transmission bar stroke feedback signal;
a driving motor, which is connected to the transmission bar and drives the transmission bar stroke; and
a motor driving circuit, which is connected to the driving motor and the motor movement automatic detecting and differentiating device, wherein the motor driving circuit receives the second duty cycle signal and the second driving current level signal to control the duty cycle of the driving gate opening and the current level that supplies the driving motor.

4. The electrical feedback fashion brake arrester of claim 3, wherein the duty cycle corresponding to the second duty cycle signal and the current level corresponding to the second current level signal are respectively inferior or equal to the duty cycle corresponding to the first duty cycle signal and the current level corresponding to the first current level signal.
